(19) United States
(12) Patent Application Publication
(10) Pub. No.: US 2026/0016282 A1
(43) Pub. Date: Jan. 15, 2026

(54) OPTICAL INTERFERENCE MEASURING METHOD

(71) Applicant: Panasonic Intellectual Property Management Co., Ltd., Osaka (JP)

(72) Inventors: YASUHIRO KABETANI, Osaka (JP); TAKASHI URASHIMA, Osaka (JP)

(21) Appl. No.: 19/331,356

(22) Filed: Sep. 17, 2025

Related U.S. Application Data
(63) Continuation of application No. PCT/JP2024/010953, filed on Mar. 21, 2024.

(30) Foreign Application Priority Data
Apr. 6, 2023 (JP) 2023-062191

(51) Int. Cl. G01B 9/02091; G01B 9/02001; G01B 9/02055

(52) U.S. Cl. CPC G01B 9/02091; G01B 9/02008; G01B 9/0207; G01B 2290/25

(57) ABSTRACT

When measurement light enters measurement object W, a range obtained by adding measurement range LD determined by an interference light detection unit from a zero point overlaps with the range obtained by subtracting measurement range LD from distance LC(=c/2FSR) from the zero point. The zero point is a point at which a signal optical path length of signal light that is the measurement light matches a reference optical path length of the reference light. The distance is a distance of a half of the value obtained by multiplying the reciprocal of mode interval FSR of optical comb generation filter 205 by light speed c. The change amount L(1-1/cos θ) of distance (L/cos θ) between scanning mechanism and measurement object W generated when scanning with scanning mechanism 211 is performed is caused to exceed twice measurement range LD determined by the interference light detection unit, that is, 2LD.

### TECHNICAL FIELD

The present disclosure relates to an optical interference measurement method for measuring a measurement object using interference light between reflected light and reference light.

### BACKGROUND ART

Optical coherence tomography (that is, OCT) is a tomographic imaging method for a structure such as a coating film or a living body using a light interference phenomenon. OCT has already been put to practical use in the field of ophthalmology, and has been used for tomographic imaging of a fine region such as a retina in an eyeball as a tomographic measurement method having a high resolution of several tens of micrometers.

There are two types of OCT: a time domain OCT that requires scanning of a reference plane (that is, TD-OCT) and a frequency domain OCT that does not require scanning of a reference plane (that is, FD-OCT). There are two types of FD-OCT: a spectrometer type (that is, SD-OCT) and a wavelength scanning light source type (that is, SS-OCT). In both types, light emitted from a light source is divided into measurement light and reference light, thereafter the measurement light and the reference light reflected from a measurement object are multiplexed, and an optical tomographic image is acquired based on a beat frequency of interference light between the measurement light and the reference light.

FIG. 5 is a diagram illustrating a conventional SD-OCT device described in PTL 1. In low coherence interferometer 3 in the device illustrated in FIG. 5, light emitted from broadband light source 2 is divided into reference light and measurement light by beam splitter 5, the reference light passes through lens 9 and mirror 10 to spectrometer 4, and the measurement light passes through lens 6 and galvanometer mirror 7 to reach measurement object 8, is reflected by measurement object 8, and then enters spectrometer 4 in the same manner.

In spectrometer 4, the measurement light and the reference light interfere with each other in the spectral domain to generate an interference signal. The interference signal reaches CCD 12 via diffraction grating 11. The CCD 12 measures interference fringes as the interference signal. By performing appropriate signal processing on this interference signal, a derivative of a one-dimensional refractive index distribution in a depth direction of measurement object 8 can be obtained. Further, a two-dimensional optical tomographic image can be obtained by obtaining the derivative of the one-dimensional refractive index distribution while shifting the position of the measurement light using galvanometer mirror 7.

### CITATION LIST

### Patent Literature

PTL 1: Unexamined Japanese Patent Publication No. 2007-127425

### SUMMARY OF THE INVENTION

An optical interference measurement method according to one aspect of the present disclosure includes:
dividing, by a light division unit, light emitted from a low coherence light source and adjusted at equal frequency intervals into measurement light and reference light; and
obtaining a surface shape profile from an interference signal of interference light in which reflected light from a measurement object and the reference light are multiplexed after the measurement light enters the measurement object while scanning with a scanning mechanism is performed using the measurement light,
wherein when the measurement light enters the measurement object, a range obtained by adding a measurement range determined by an interference light detection unit from a zero point overlaps with a range obtained by subtracting the measurement range from a distance from the zero point. The zero point is a point at which a signal optical path length of signal light that is the measurement light and a reference optical path length of the reference light match each other. The distance is a distance of a half of a value obtained by multiplying a reciprocal of a mode interval of an optical comb generation filter by a light speed from the zero point, and
a change amount of a distance between the scanning mechanism and the measurement object generated when the scanning with the scanning mechanism is performed exceeds twice the measurement range when the scanning with the scanning mechanism is performed.

### BRIEF DESCRIPTION OF THE DRAWINGS

FIG. 1 is a diagram illustrating an overall configuration of an SD-OCT device in an exemplary embodiment.

FIG. 2A is a diagram of a Fabry-Perot filter in the exemplary embodiment.

FIG. 2B is a diagram illustrating an optical output of an optical frequency comb light source in a frequency domain.

FIG. 2C is a diagram illustrating transmittance of the optical frequency comb light source in a frequency domain.

FIG. 2D is a diagram illustrating an optical output of the optical frequency comb light source in a frequency domain.

FIG. 3 is a diagram of a coherence domain of an SD-OCT device in a first exemplary embodiment.

FIG. 4A is a diagram of displacement with respect to a scanning angle in the first exemplary embodiment.

FIG. 4B is a diagram of interference signal z (θ) obtained by measuring W (θ).

FIG. 4C is a diagram of a conversion from an interference signal to a surface shape in the first exemplary embodiment.

FIG. 5 is a diagram illustrating a conventional SD-OCT device described in PTL 1.

### DESCRIPTION OF EMBODIMENT

The measurement range in a depth direction in an SD-OCT device, that is, half of the maximum value of the optical path length difference between the reference light and the measurement light with which the spectral interference fringes are correctly obtained is limited by the optical frequency resolution of the spectrometer. Thus, in a conventional configuration, a change in the distance to measurement object 8 generated when the scanning with galvanometer mirror 7 as a scanning mechanism is performed cannot be made larger than the measurement range in the depth direction, and there is a problem that the measurable size of measurement object 8 in the scanning direction is limited.

The present disclosure solves the conventional problem, and an object of the present disclosure is to provide an optical interference measurement method capable of performing measurement even when the change in the distance to a measurement object generated when scanning is performed is larger than a measurement range in the depth direction.

Hereinafter, exemplary embodiments of the present disclosure will be described with reference to the drawings.

### Exemplary Embodiment

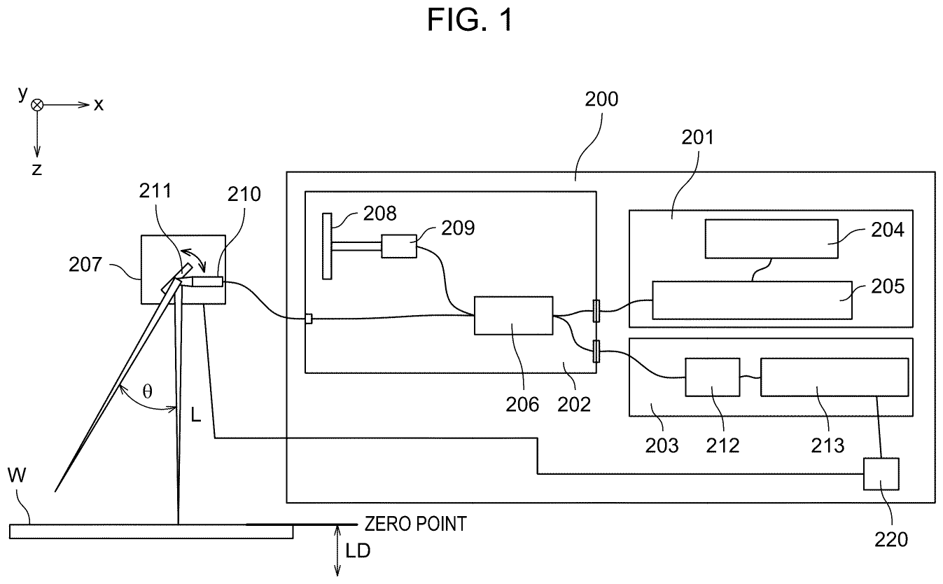

FIG. 1 is a diagram illustrating an overall configuration of SD-OCT (spectrometer type optical coherence tomography) device 200 and scanning mechanism 211 as an example of an optical interference measurement device that implements an optical interference measurement method according to an exemplary embodiment.

SD-OCT device 200 includes at least optical frequency comb light source 201, coupler 206 as an example of a light division unit, and detector array 213 as an example of an interference light detection unit. Optical frequency comb light source 201 includes low coherence light source 204 and optical comb generation filter 205. In FIG. 1, SD-OCT device 200 further includes optical fiber interferometer 202 that is a Michelson interferometer, spectrometer 203 having an interference light detection unit, and calculation unit 220.

Optical frequency comb light source 201 is a light source having an optical frequency distribution at equal intervals. Optical frequency comb light source 201 includes low coherence light source 204 and optical comb generation filter 205 that adjusts low coherence light emitted from low coherence light source 204 to an optical frequency distribution at equal intervals. Low coherence light source 204 includes an SLD (super luminescent diode), an ultrashort pulse laser, a super continuous light source, or the like. The optical frequency of the light emitted from low coherence light source 204 is formed into an optical frequency distribution at equal intervals, that is, a comb shape at equal frequency intervals by optical comb generation filter 205. Details of the optical frequency to be formed will be described later.

The light generated from optical frequency comb light source 201 enters optical fiber interferometer 202.

Optical fiber interferometer 202 includes coupler 206 connected to two light receiving ports and two light sending ports.

A light emitting port of optical frequency comb light source 201 is connected to a first light receiving port of two light receiving ports of optical fiber interferometer 202, and the light is divided into measurement light and reference light by coupler 206. The light sending port of coupler 206 is connected to measurement head 207 outside optical fiber interferometer 202 as signal light, and is also connected to collimator lens 209 that emits light to reference surface 208 as reference light.

The reference light enters coupler 206 through collimator lens 209 after being reflected by reference surface 208, and enters spectrometer 203 from a second light receiving port of the two light receiving ports of optical fiber interferometer 202.

On the other hand, the measurement light is emitted through irradiation lens 210 and scanning mechanism 211 at measurement head 207 to measurement object W, enters coupler 206 from measurement head 207 through reflection or scattering at measurement object W, and enters spectrometer 203 from the second light receiving port of optical fiber interferometer 202.

In optical fiber interferometer 202, a point at which the signal optical path length of the signal light as the measurement light matches the reference optical path length of the reference light, that is, a zero point is illustrated in FIG. 1. The position of the zero point in the exemplary embodiment can be freely changed, for example, by changing the distance between collimator lens 209 and reference surface 208 or the distance in the fiber between coupler 206 and collimator lens 209, and can also be disposed between measurement head 207 and coupler 206, for example.

Calculation unit 220 performs measurement processing such as calculation based on information from detector array 213 and scanning mechanism 211 described later to obtain a surface shape profile of measurement object W.

Spectrometer 203 includes diffraction grating 212 connected to optical fiber interferometer 202 and detector array 213 connected to diffraction grating 212. The two pieces of light of the measurement light and the reference light are simultaneously dispersed by diffraction grating 212 of spectrometer 203, and interfere in the optical frequency domain to become interference light in which reflected light and the reference light are multiplexed. As a result, an interference signal of the interference light is measured by detector array 213 as an example of the interference light detection unit.

By performing appropriate signal processing on this interference signal at calculation unit 220, a derivative of a one-dimensional refractive index distribution in the signal optical path of the measurement light of measurement object W, that is, a reflectance distribution can be obtained. Here, it is defined that the positive and negative signs of the optical path length difference are determined by whether the calculation result obtained by subtracting the reference optical path length from the signal optical path length is positive or negative.

At this time, as described above, when the finite measurement range in the depth direction that can be measured by SD-OCT device 200 is defined as LD, the measurable maximum range is a range of ±LD centered on the zero point. When the optical frequency that can be resolved by one pixel of detector array 213 is defined as frequency resolution dv, the maximum time difference between the measurement light and the reference light observed by spectrometer 203 is ½ dv according to the Nyquist sampling theorem. This means that, when converted to a depth, that is, a reciprocating distance,

$$LD = c / 4 dv \qquad ( 1 )$$

forms where c is a light speed, in which measurement range LD is larger as frequency resolution dv of spectrometer 203 is better, but there is a limit because frequency resolution dv is limited by the finite number of pixels of detector array 213.

Scanning mechanism 211 is an element capable of changing the reflection direction of the measurement light, for example, a galvanometer scanner, a polygon scanner, or a resonance scanner, and can performing scanning with the measurement light in a θ direction. The surface shape of measurement object W in an X direction can be measured by continuously performing scanning with the measurement light in the θ direction using scanning mechanism 211.

### <Optical Frequency Comb Generator>

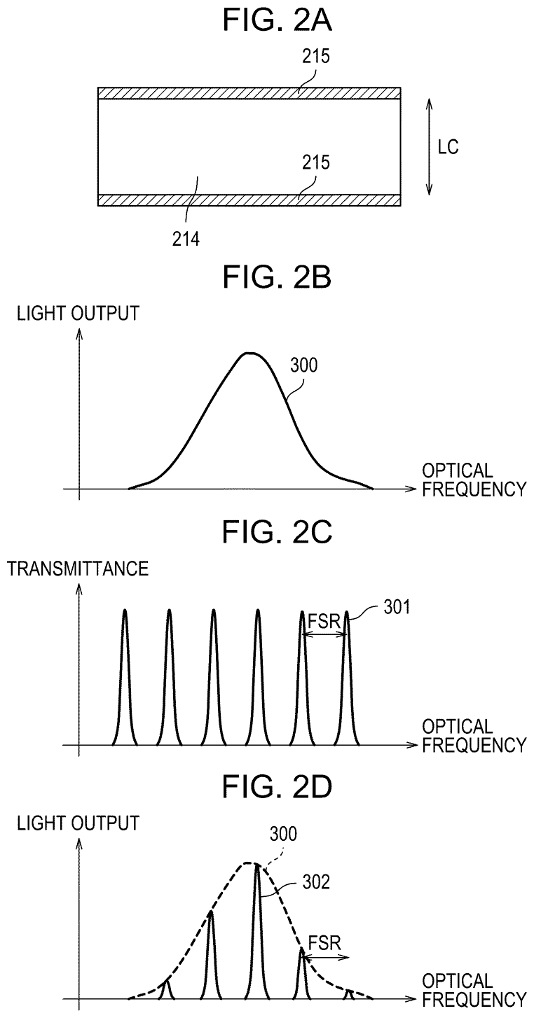

An output spectrum generated by optical frequency comb light source 201 which is an optical frequency comb generator will be described with reference to FIGS. 2A to 2D. As an example, optical comb generation filter 205 is a Fabry-Perot filter in a range of finesse 2 to 20 constituting an optical resonator by sandwiching air gap 214 having cavity length LC using two half mirror pairs 215 having reflectance R, as illustrated in FIG. 2A. To the output of low coherence light source 204 that has passed through optical comb generation filter 205, in the time domain, a time delay of

$$2 LC / c \times n \qquad ( 2 )$$

is added. n is the number of times for reciprocation of light in the optical resonator, and n=0, 1, 2, and 3 forms

FIG. 2B is a diagram illustrating a pre-filter output of optical frequency comb light source 201, FIG. 2C is a diagram illustrating a filter transmittance of optical frequency comb light source 201, and FIG. 2D is a diagram illustrating an output of optical frequency comb light source 201 in a frequency domain. In FIGS. 2B to 2D, the vertical axis represents light output, transmittance, and light output, respectively, and the horizontal axis represents optical frequency.

In optical comb generation filter 205, original spectrum 300 (see FIG. 2B) of low coherence light source 204 is multiplied by transmittance spectrum 301 (see FIG. 2C) of optical comb generation filter 205, and adjusted to comb-like output spectrum 302 (see FIG. 2D) in which the mode of equal mode interval FSR stands.

Mode interval FSR at this time is represented by

$$FSR = c / 2 LC \qquad ( 3 )$$

using light speed c and cavity length LC.

Here, optical frequency comb light source 201 does not have to be a combination of low coherence light source 204 and optical comb generation filter 205, but it may be a mode-locked laser in which a repetition frequency is stabilized, a mode in which a single mode laser is modulated by an electro-optical element to form a comb mode, or a high-finesse etalon.

Here, coupler 206 is used for light multiplexing, but optical fiber interferometer 202 may be constructed in a free space using a beam splitter or may be substituted by using an element such as an optical circulator.

### <Coherence Domain of SD-OCT Device>

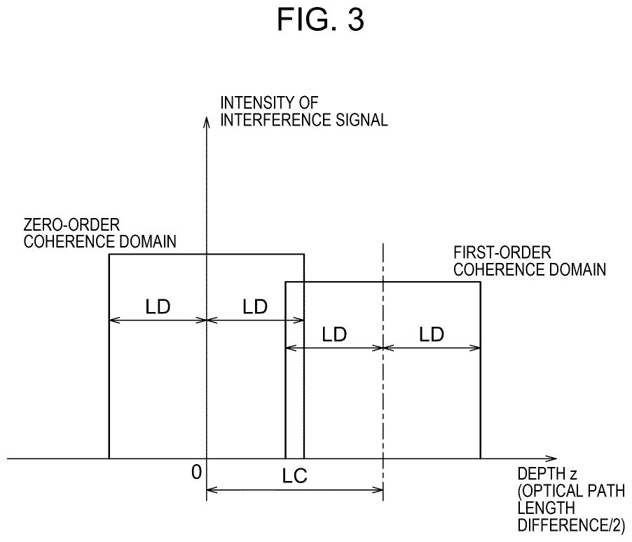

FIG. 3 illustrates a coherence domain of SD-OCT device 200 according to the exemplary embodiment. Here, a range of the optical path length difference in which the interference signal can be obtained is referred to as a coherence domain. In the coherence domain, when the vertical axis represents the intensity of the interference signal and the horizontal axis represents depth z in a light axis direction (=optical path length difference/2), a Lorentz function centered on the zero point is drawn, but here, for simplicity, the intensity of the interference signal is constant, and the width is a rectangle of ±LD.

In the vicinity of the zero point where the optical path length difference between the signal optical path and the reference optical path is 0, an interference signal is detected in the range of the optical path length difference 0±LD. This is defined as a zero-order coherence domain.

Further, when the optical path length difference between the signal optical path and the reference optical path is further separated by +2LC, that is, when depth z is separated by +LC, the interference signal can be obtained even in the region of the depth LC±LD. When considered in the time domain, it can be considered that the light having a time delay of 2LC/c×(n+1) and the light having a time delay of 2LC/c×n because of optical comb generation filter 205 cancel the time difference each other with the time difference of 2LC/c for reciprocation between the zero point and measurement object W and interfere with each other. This is defined as a first-order coherence domain.

In the same manner, when the optical path length difference between the signal optical path and the reference optical path is further separated by +2LC, that is, when depth z is separated by +2LC, the interference signal can also be obtained in the region of the depth 2LC±LD.

The range of cavity length LC needs to satisfy LC<2LD as illustrated in FIG. 3. By having such a cavity length, an overlapping region between the zero-order coherence domain and the first-order coherence domain can be provided, and a dead zone between the zero-order coherence domain and the first-order coherence domain can be eliminated. In other words, it means that the range obtained by adding measurement range LD determined by the interference light detection unit from the zero point is set to overlap with a range obtained by subtracting measurement range LD from distance LC(=c/2FSR) that is half a value (c/FSR) obtained by multiplying the reciprocal of mode interval FSR of optical comb generation filter 205 by light speed c from the zero point.

On the other hand, it is not preferable to further reduce cavity length LC and set LC<LD because such a reduced cavity length causes the interference signal caused by optical comb generation filter 205 to be always observed at the position of depth LC, resulting in compression of the dynamic range on the measurement side and degradation of the sensitivity.

Thus, as an example, cavity length LC is preferably between LD<LC<2LD.

At this time, in FIG. 3, two coherence domains overlap between LC-LD and LD.

In this region, two interference signals are obtained. How to distinguish the two interference signals will be described later.

<Signal at the Time of Scanning with Scanning Mechanism>

The surface of measurement object W that can be measured in the zero-order coherence domain needs to be in a position of measurement range ±LD determined by frequency resolution dv of spectrometer 203 from the zero point (a range obtained by adding measurement range ±LD determined by the interference light detection unit from the zero point).

When an incident angle (that is, a scanning angle) of the measurement light emitted from scanning mechanism 211 with respect to measurement object W at the time of scanning with scanning mechanism 211 is θ, the distance between measurement object W and scanning mechanism 211 is L/cos θ. At this time, a change amount of the distance, that is, a difference from shortest distance L is L(1-1/cos θ). Here, to make the change in the distance to measurement object W due to the scanning with scanning mechanism 211 larger than the measurement range in the depth direction, change amount L(1-1/cos θ) of distance (L/cos θ) between scanning mechanism 211 and measurement object W generated when the scanning is performed is set to exceed twice measurement range LD determined by the interference light detection unit, that is, 2LD. For simplicity, when the zero point is caused to match L, and the displacement with respect to shortest distance L from the rotation center of scanning mechanism 211 to the surface of measurement object W with respect to scanning angle θ is W (θ),

$$W ( θ ) = L ( 1 / cos θ - 1 ) \qquad ( 4 )$$

forms. Displacement W (θ) indicates the surface shape profile of measurement object W based on distance L.

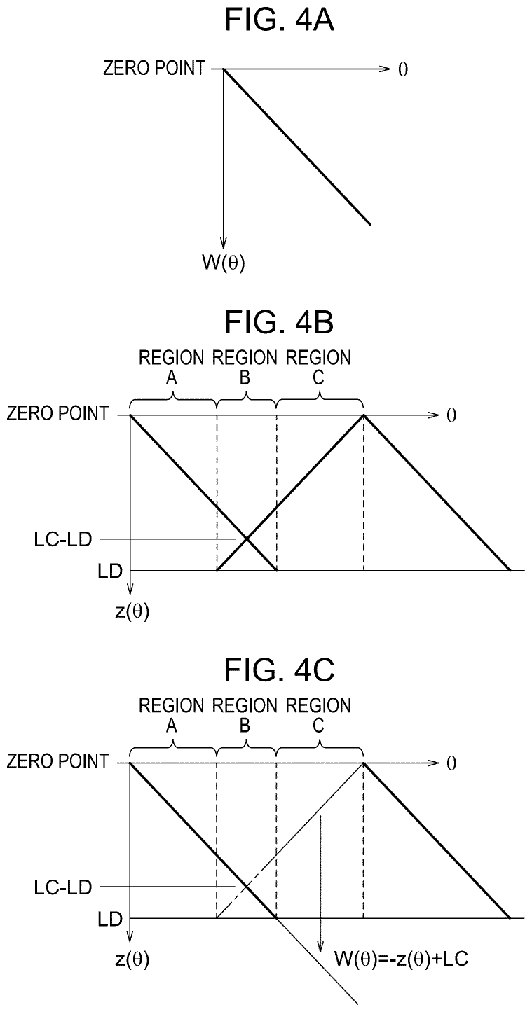

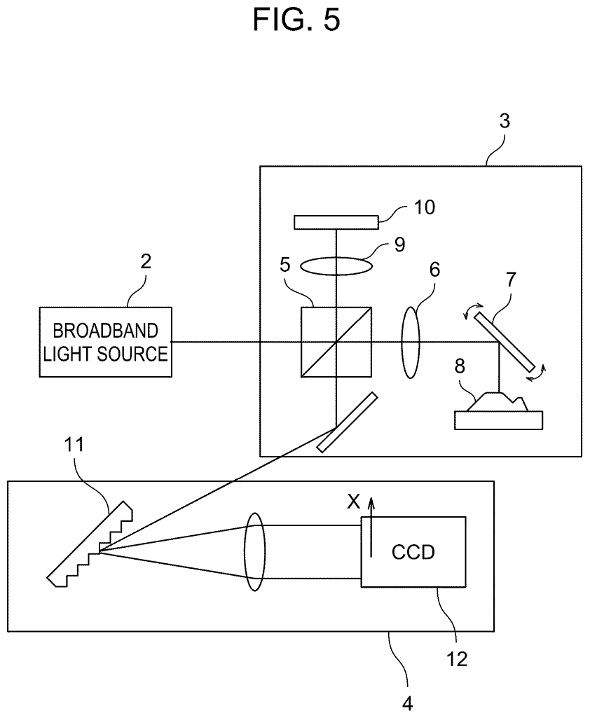

FIG. 4A illustrates a relationship of displacement W (θ) with respect to scanning angle θ when scanning with scanning mechanism 211 is performed. When scanning angle θ increases, the distance between measurement object W and scanning mechanism 211 increases, and displacement W (θ) increases. Originally, displacement W (θ) with respect to scanning angle θ is nonlinear as in the formula, but is illustrated as linear for simplicity of description because it is a monotonic increase.

FIG. 4B illustrates interference signal z (θ) obtained by observing displacement W (θ) with SD-OCT device 200.

Region A illustrated in FIG. 4B is a region where the depth of the interference signal is located between the zero point and LC-LD. Here, the interference signal is only in the zero-order coherence domain, and one interference signal is obtained. In region A, interference signal z (θ) to be observed is taken as displacement W (θ) as it is.

Region B illustrated in FIG. 4B is a region where depth z of the interference signal is located between LC-LD and LD. Here, since the interference signal is included in both the zero-order coherence domain and the first-order coherence domain, two interference signals are obtained as interference signal z (θ) to be observed. When the two interference signals are obtained, conversion into displacement W (θ) with respect to shortest distance L of the distance to the surface of measurement object W needs to be performed.

At this time, since what is desired to be truly obtained as the depth is the zero-order interference signal, one of the two interference signals that monotonously decreases with respect to the θ direction, that is, one of z (θ) whose inclination with respect to scanning angle θ is negative is determined as the zero-order interference signal, and is set as displacement W (θ).

Region C illustrated in FIG. 4B is a region where depth z of the interference signal is located from LD to LC. Here, the interference signal is located only in the first-order coherence domain, and one interference signal is obtained.

Usually, the interference signal can be obtained only in region A and region B, but as illustrated in FIG. 3 above, since the coherence domain is continuously provided in the depth z direction, the interference signal can be obtained also in region C where depth z is outside the zero-order coherence domain.

Although the interference signal is obtained in region C, the actual depth is obtained as an image in which the depth is folded back in zero point symmetry. It can be determined that the depth is obtained as an image in which the depth is folded back because, originally, displacement W (θ) should be monotonically decreasing, but the displacement monotonically increasing with respect to the scanning angle θ. The zero point here indicates zero point LC of the first-order coherence domain. Thus, when the surface shape is converted into the actual surface shape, the interference signal is inversely corrected to eliminate the zero point symmetry, and

$$W ( θ ) = - z ( θ ) + LC \qquad ( 5 )$$

folds.

In this manner, in calculation unit 220, the depth of the interference signal is directly adopted as the surface shape profile in region A where one interference signal is obtained, the interference signal having a negative inclination with respect to θ is adopted in region B where two interference signals are obtained, and the interference signal is inversely corrected to eliminate the zero-point symmetry in region C where a folded image is obtained, whereby the surface shape profile can be obtained from the obtained interference signals. That is, in calculation unit 220, in region B where two interference signals of the interference light are observed, one of the two interference signals is selected using the sign of the change in the distance of the interference light with respect to scanning angle θ of scanning mechanism 211, and in regions A and C where one interference signal is observed, calculation unit 220 determines whether to inversely correct the interference signal using the sign of the change in the distance of the interference light with respect to scanning angle θ of scanning mechanism 211. When the inversion correction is performed on the interference signal with calculation unit 220, the sign of the observed distance is inverted as in Formula (5), and half of the value obtained by multiplying the reciprocal of mode interval FSR of the optical comb generation filter by light speed c, c/2FSR, that is, LC, is added. As a result, the surface shape profile can be obtained from the obtained interference signal, and the surface position can be measured. An overview of this point is illustrated in FIG. 4C.

This method is not preferable when scanning mechanism 211 discretely changes the measurement position because determination based on the inclination with respect to scanning angle θ cannot be performed.

Also when scanning of scanning mechanism 211 is continuously performed, non-flat symmetry in which displacement W (θ) shows a discrete change, for example, a stepwise manner, is also not preferable, and it is necessary to continuously perform scanning at scanning angle θ with respect to a flat measurement object.

As described above, in the interference measurement method according to the present exemplary embodiment, it is set in advance that, when the measurement light enters measurement object W, the range obtained by adding measurement range LD determined by detector array 213 as an example of the interference light detection unit from the zero point at which the signal optical path length of the signal light that is the measurement light matches the reference optical path length of the reference light overlaps with the range obtained by subtracting measurement range LD from distance LC=c/2FSR that is a half of the value obtained by multiplying the reciprocal of mode interval FSR of optical comb generation filter 205 by light speed c from the zero point, and at the same time, it is set in advance that when scanning with scanning mechanism 211 is performed, change amount L(1-1/cos θ) of distance L/cos θ between scanning mechanism 211 and measurement object W generated when scanning with scanning mechanism 211 is performed to exceed twice measurement range LD determined by the interference light detection unit, that is, 2LD. The following optical interference measurement method is performed in such a setting state. That is, as the optical interference measurement method, the method includes:
emitting low coherence light from low coherence light source 204;
adjusting light emitted from low coherence light source 204 to an optical frequency distribution at equal intervals with optical comb generation filter 205;
dividing light adjusted at equal frequency intervals by optical comb generation filter 205 into measurement light and reference light with coupler 206 as an example of a light division unit; and
detecting interference light obtained by multiplexing the reflected light from measurement object W and the reference light after the measurement light enters the measurement object with an interference light detection unit while performing scanning with scanning mechanism 211 at scanning angle θ at which the measurement light enters measurement object W.

A surface shape profile of measurement object W can be obtained from the interference signal of the detected interference light.

According to the present exemplary embodiment, the light adjusted at equal frequency intervals by optical comb generation filter 205 is divided into measurement light and reference light. When the measurement light enters measurement object W, the range obtained by adding measurement range LD determined by the interference light detection unit from the zero point at which the signal optical path length of the signal light that is the measurement light matches the reference optical path length of the reference light overlaps with the range obtained by subtracting measurement range LD from distance LC(=c/2FSR) that is a half of the value (c/FSR) obtained by multiplying the reciprocal of mode interval FSR of optical comb generation filter 205 by light speed c from the zero point, and when scanning with scanning mechanism 211 is performed, change amount L(1-1/cos θ) of distance (L/cos θ) between scanning mechanism 211 and measurement object W generated when scanning with scanning mechanism 211 is performed is caused to exceed twice measurement range LD determined by the interference light detection unit, that is, 2LD. With this configuration, the surface shape of measurement object W can be continuously measured even when the change in the distance to measurement object W generated when scanning is performed is larger than the measurement range.

Any exemplary embodiments or modifications are appropriately combined in the various exemplary embodiments or modifications described above, and thus, the effect possessed by each of the exemplary embodiments or modifications can be achieved. Combination of exemplary embodiments, combination of examples, or combination of exemplary embodiments and examples are possible, and features in different exemplary embodiments or examples are also possible.

As described above, according to the optical interference measurement method, the light adjusted at equal frequency intervals by the optical comb generation filter is divided into measurement light and reference light with a light division unit, wherein when the measurement light enters the measurement object, a range obtained by adding a measurement range determined by the interference light detection unit from a zero point at which a signal optical path length of signal light that is the measurement light and a reference optical path length of the reference light match each other overlaps with a range obtained by subtracting the measurement range from a distance of a half of a value obtained by multiplying a reciprocal of a mode interval of the optical comb generation filter by a light speed from the zero point, a change amount of a distance between the scanning mechanism and the measurement object generated when the scanning with the scanning mechanism is performed is caused to exceed twice the measurement range when the scanning with the scanning mechanism is performed, and interference light in which the reflected light of the measurement light from the measurement object and the reference light are multiplexed is detected by the interference light detection unit.

With this configuration, the surface shape of the measurement object can be continuously measured even when the change in the distance to the measurement object generated when scanning is performed is larger than the measurement range.

### INDUSTRIAL APPLICABILITY

The optical interference measurement method according to the above aspect of the present disclosure has a feature that the surface shape of a measurement object can be continuously measured even when the change in the distance to the measurement object generated when scanning is performed is larger than the measurement range, and the surface shape can be measured in a wide range over a long distance. The method can also be applied to uses such as precise measurement in an industrial field.

### REFERENCE MARKS IN THE DRAWINGS

2: broadband light source
3: low coherence interferometer
4: spectrometer
5: beam splitter
6: lens
7: galvanometer mirror
8: measurement object
9: lens
10: mirror
11: diffraction grating
12: CCD
200: SD-OCT device
201: optical frequency comb light source
202: optical fiber interferometer
203: spectrometer
204: low coherence light source
205: optical comb generation filter
206: coupler
207: measurement head
208: reference surface
209: collimator lens
210: irradiation lens
211: scanning mechanism
212: diffraction grating
213: detector array
214: air gap
215: pair of half mirrors
220: calculation unit
LD: measurement range
L: distance to measurement object W
W: measurement object
dv: frequency resolution
LC: cavity length
FSR: mode interval
R: reflectance
W(θ): surface shape profile of measurement object W based on distance L
θ: scanning angle

1. An optical interference measurement method comprising:
dividing, by a light division unit, light emitted from a low coherence light source and adjusted at equal frequency intervals into measurement light and reference light; and
obtaining a surface shape profile from an interference signal of interference light in which reflected light from a measurement object and the reference light are multiplexed after the measurement light enters the measurement object while scanning with a scanning mechanism is performed using the measurement light,
wherein when the measurement light enters the measurement object, a range obtained by adding a measurement range determined by an interference light detection unit from a zero point overlaps with a range obtained by subtracting the measurement range from a distance from the zero point, the zero point being a point at which a signal optical path length light that is the measurement light and a reference optical path length of the reference light matches each other, the distance being a distance of a half of a value obtained by multiplying a reciprocal of a mode interval of an optical comb generation filter by a light speed, and
a change amount of a distance between the scanning mechanism and the measurement object generated when the scanning with the scanning mechanism is performed exceeds twice the measurement range when the scanning with the scanning mechanism is performed.

2. The optical interference measurement method according to claim 1, wherein
the obtaining the surface shape profile of the measurement object from the interference light includes:
selecting one of two interference signals using a sign of a change in a distance of the interference light with respect to a scanning angle of the scanning mechanism in a region where the two interference signals of the interference light are observed, and
determining whether an inversion correction is performed on the interference signal using the sign of the change in the distance of the interference light with respect to the scanning angle of the scanning mechanism in a region where one interference signal is observed.

3. The optical interference measurement method according to claim 2, further comprising performing the inversion correction of the interference signal, the inversion correction of the interference signal including inverting a sign of the distance that has been observed and adding a half of a value obtained by multiplying the reciprocal of the mode interval of the optical comb generation filter by the light speed.

4. The optical interference measurement method according to claim 3, further comprising:
emitting the low coherence light from the low coherence light source, the low coherence light source being any light source of a super luminescent diode, an ultrashort pulse laser, and a super continuum light source, and light emitted from the light source is the low coherence light, and
adjusting the light emitted from the low coherence light source to an optical frequency distribution at equal intervals with the optical comb generation filter, the optical comb generation filter being a Fabry-Perot filter in a range of a finesse of 2 to 20.
